(19) United States
(12) Patent Application Publication
(10) Pub. No.: US 2011/0232119 A1
(43) Pub. Date: Sep. 29, 2011

(54) Sports yard tape

(76) Inventor: Andre N. Smalls, Abingdon, MD (US)

(21) Appl. No.: 13/065,110

(22) Filed: Mar. 14, 2011

Related U.S. Application Data
(60) Provisional application No. 61/340,046, filed on Mar. 12, 2010.

(51) Int. Cl. G01B 3/10

(52) U.S. Cl. 33/701; 33/771

(57) ABSTRACT

The present invention provides an improved design of tape measures. The Sports Yard Tape is similar in appearance to a traditional tape measure and as such features square-shaped, durable outer casing made of a hard plastic or, in another embodiment, metal material. The measuring blade is internally coiled within this casing, Mylar™-coated for added durability and featuring a metallic anchoring hook at its proximal end. Yet, unique to the Sports Yard Tape and what sets it apart from standard units is found in found in the measurements imprinted on the surface of the tape. While the Sports Yard Tape features standard millimeter, centimeter, inch and feet measurements, most prominently displayed are measurements classified by yards. As such, every thirty-six inches, the designated yardage is clearly imprinted on the surface of the tape.

### CLAIM OF PRIORITY

This patent application claims priority under 35 USC 119 (e) (1) from U.S. Provisional Patent Application Ser. No. 61/340,046 filed Mar. 12, 2010, of common inventorship herewith entitled, “Sports Yard Tape.”

### FIELD OF THE INVENTION

The present invention pertains to the field of measuring devices, and more specifically to the field of linear measuring devices.

### BACKGROUND OF THE INVENTION

The prior art has put forth several designs for linear measuring devices. Among these are:

U.S. Pat. No. 5,062,215 to George J. Schlitt describes a measuring tape which includes a measuring scale on both sides of the metal tape. The upper surface of the tape is scaled from zero to a number equal to the length of the tape, and the underside of the tape is scaled from the length of the tape of a measurement equal to twice the length of the tape. Thus the tape can be used to measure a distance equal to twice its length.

U.S. Pat. No. 6,237,343 to Patrick J. Cook describes an improved tape measure and an adhesive strip for a tape measure. The tape has one end secured within the case, the other free end being extendible from the case to a substantially full length of the tape.

U.S. Pat. No. 7,343,694 to Jeffrey Erdfarb describes a measuring device, such as a ruler, tape measure, etc. which includes a first edge having a first set of indicia corresponding to a first linear scale, and a second edge having a second set of indicia corresponding to a second linear scale. The first linear scale may be actual, while the second linear scale may be non-actual, such as a linear scale employed on an engineering or architectural drawing.

None of these prior art references describe the present invention.

### SUMMARY OF THE INVENTION

It is an object of the present invention to provide a linear measuring device.

### BRIEF DESCRIPTION OF THE DRAWINGS

FIG. 1 is an elevational angled perspective view of the device of the present invention retracted within its case.

FIG. 2 is a close-up elevational angled perspective view of a portion of the device of the present invention.

FIG. 3 is an elevational angled perspective view of the device of the present invention.

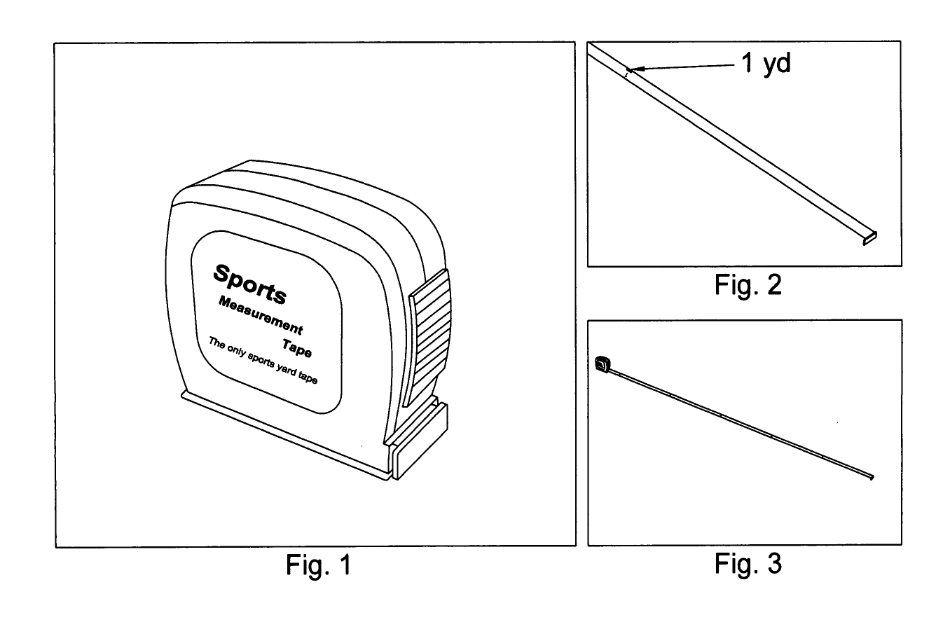

### DETAILED DESCRIPTION OF THE INVENTION

The present invention, hereinafter referred as the Sports Yard Tape is a practical enhancement to the design of tape measures. The Sports Yard Tape is similar in appearance to a traditional tape measure and as such features square-shaped, durable outer casing made of a hard plastic or, in another embodiment, metal material. The measuring blade is internally coiled within this casing, Mylar™-coated for added durability and featuring a metallic anchoring hook at its proximal end. Yet, unique to the Sports Yard Tape and what sets it apart from standard units is found in the measurements imprinted on the surface of the tape. While the Sports Yard Tape features standard millimeter, centimeter, inch and feet measurements, most prominently displayed are measurements classified by yards. As such, every thirty-six inches, the designated yardage is clearly imprinted on the surface of the tape. To use the Sports Yard Tape, the user needs only to flush mount the measuring tape over the surface area which they are measuring. For instance, a referee utilizes the Sports Yard Tape to measure the yardage gained during a football game, while a contractor utilizes this unique measuring tape to measure yards of lumber.

There are several significant benefits and advantages associated with this clever product invention. Foremost, the Sports Yard Tape provides consumers with a simple way in which to measure yards. Particularly well suited for sports use, especially football, this advanced measuring system provides better accuracy in determining down distance during games than the current method of poles and chains. As such, use of this product effectively brings the system of down measurement into the twenty-first century. As the chain system relies more on judgment than scientific accuracy, the Sports Yard Tape eliminates all guesswork in down determination. A fully functioning tape measure, the Sports Yard Tape enables contractors and do-it-yourselfers to measure a variety of goods in a simple and easy fashion. Easy to use, this versatile product completes a multitude of measuring tasks in a matter of minutes. With the simple extraction of the tape blade, taking yard measurements is a snap for even the most inexperienced handyman or woman.

Made of durable, high quality materials, the Sports Yard Tape withstands years of continued use.

An innovative product invention, the Sports Yard Tape readily enhances the task of measuring yards. Compact and lightweight, this handy device proves an invaluable addition to any equipment box, tool box or utility drawer.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved linear measuring device, comprising a square-shaped, durable outer casing, wherein the measuring blade is internally coiled within the casing, and is Mylar™-coated for added durability and further comprising a metallic anchoring hook at its proximal end, the improvement comprising millimeter, centimeter, inch, feet and yard measurements, wherein the yard measurements are most prominently displayed.

2. The device of claim 1 wherein the outer casing comprises hard plastic material.

3. The device of claim 1 wherein the outer casing comprises metal material.

4. A method of measuring yards, comprising:
extending the coiled measuring tape from its casing, placing the extended measuring tape near the surface to be measured, looking at the extended tape measure and reading the number of yards adjacent to the desired place of measurement.
